(19) United States
(12) Patent Application Publication
(10) Pub. No.: US 2017/0082898 A1
(43) Pub. Date: Mar. 23, 2017

(54) Alignment Apparatus, Display Panel and Display Device

(71) Applicants: BOE Technology Group Co., Ltd., Beijing (CN); Hefei Xinsheng Optoelectronics Technology Co., Ltd., Anhui (CN)

(72) Inventors: Liangliang Jiang, Beijing (CN); Quan Gan, Beijing (CN); Lei Guo, Beijing (CN); Fengzhen Lv, Beijing (CN); Yong Jun Yoon, Beijing (CN)

(21) Appl. No.: 15/135,011

(22) Filed: Apr. 21, 2016

(30) Foreign Application Priority Data
Sep. 17, 2015 (CN) 201510594188.1

(51) Int. Cl. G02F 1/1337

(52) U.S. Cl. CPC G02F 1/133788; G02F 1/133723

(57) ABSTRACT

An alignment apparatus, a display panel and a display device are disclosed. The alignment apparatus includes a base and an ultraviolet lamp. The base is provided with a support surface configured to support a substrate; and a film capable of being aligned by photo-alignment is disposed on a surface. The ultraviolet lamp is disposed above the support surface, and the ultraviolet lamp is configured to rotate around a line perpendicular to the support surface in a plane parallel to the support surface of the base, or the base is configured to rotate around the line perpendicular to the support surface of the base.

This application claims priority to and the benefit of Chinese Patent Application No. 201510594188.1 filed on Sep. 17, 2015, which application is incorporated herein in its entirety.

### TECHNICAL FIELD

At least one embodiment of the present disclosure relates to an alignment apparatus, a display panel and a display device.

### BACKGROUND

A mainstream liquid crystal display panel adopts a rectangular design, and a non-rectangular display also has a wide application field. For example, an oval display can be used as a digital frame, automobile and household appliance instruments and the like; a circular display can be used for manufacturing a novel and unique mobile phone panel, a monitoring device, a panel of a game console and the like.

Generally, before an array substrate and a color filter substrate are cell-assembled to form a liquid crystal display panel, a layer of alignment film (for example, PI film) is coated on a surface of each substrate. Grooves in a certain alignment are formed on the alignment films by adopting an alignment apparatus through rubbing. Anchoring energy of the grooves in an ordered direction enables liquid crystal molecules to be slantingly and directionally arranged in a same direction at a certain pre-tilt angle.

### SUMMARY

At least one embodiment of the disclosure provides an alignment apparatus, a display panel and a display device to form an alignment direction such as an arc alignment direction or a circular alignment direction to obtain better alignment effect.

At least one embodiment of the disclosure provides an alignment apparatus comprises a base and an ultraviolet lamp. The base is provided with a support surface configured to support a substrate with a film capable of being aligned by photo-alignment. The ultraviolet lamp is disposed above the support surface, and the ultraviolet lamp is configured to rotate around a line perpendicular to the support surface in a plane parallel to the support surface of the base, or the base is configured to rotate around the line perpendicular to the support surface of the base.

At least one embodiment of the disclosure provides a display panel comprising an alignment film, wherein the alignment film in the display panel is formed by the alignment apparatus provided by the embodiments of the present disclosure.

At least one embodiment of the disclosure provides a display device comprising the display panel provided by the embodiments of the present disclosure.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic diagram of an alignment process by utilizing an alignment roller;

FIG. 2a is a structural schematic diagram of an alignment apparatus provided by one embodiment of the present disclosure;

FIG. 2b is a structural schematic diagram of another alignment apparatus provided by one embodiment of the present disclosure;

FIG. 2c is a structural schematic diagram of an ultraviolet lamp in the alignment apparatus provided by one embodiment of the present disclosure;

FIG. 2d is a structural schematic diagram of another alignment apparatus provided by one embodiment of the present disclosure;

FIG. 2e is a structural schematic diagram of another alignment apparatus provided by one embodiment of the present disclosure;

FIG. 3 is a structural schematic diagram of the alignment apparatus in A direction provided by one embodiment of the present disclosure as illustrated in FIG. 2a.

### REFERENCE NUMERALS

01—rubbing roller; 02—substrate; 1—base; 11—support surface; 110—a line perpendicular to the support surface; 2—substrate; 21—photo-alignment film; 211—alignment direction; 3—ulravoilet lamp; 4—alignment chamber; 5—pivoting shaft; 51—axis of a pivoting shaft; 10—polarizer.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the components or the objects stated before these terms encompass the components or the objects and equivalents thereof listed after these terms, but do not preclude the other components or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

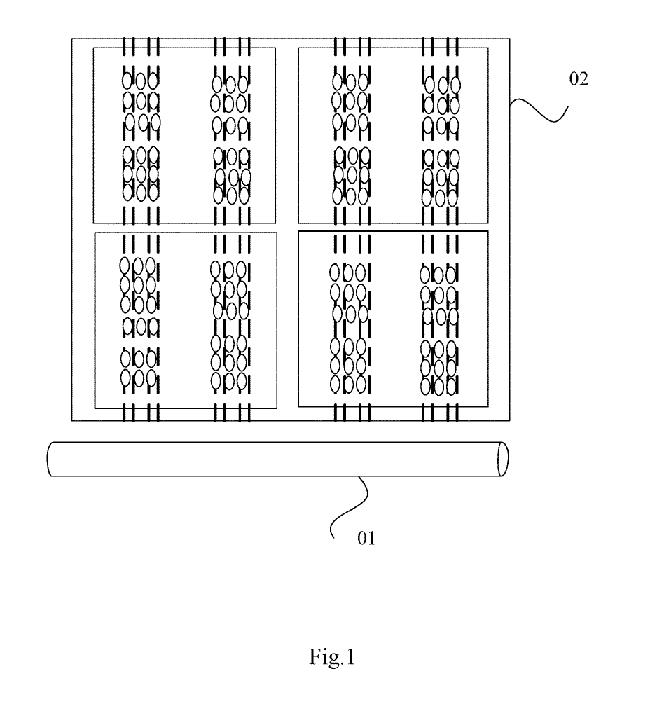

FIG. 1 illustrates a schematic diagram of an alignment process by utilizing an alignment apparatus. Generally, according to a rubbing alignment mode, a rubbing roller 01 is utilized to roll on a substrate 02 and fluff of the rubbing roller rubs an alignment film so as to form pre-tilt angles in a uniform direction.

With respect to a rectangular liquid crystal display, grooves on a substrate in a non-rectangular (e.g., arc) liquid crystal display panel need to be arranged in an outline (e.g., radian) direction of the non-rectangular (e.g., arc) liquid crystal display panel. However, rubbing alignment is performed on an integral glass substrate by a rubbing roller for once, and all the grooves on a surface of an integral liquid crystal display panel are in the same straight line direction, and thus, the grooves with non-rectangular outlines (e.g., arc) cannot be realized.

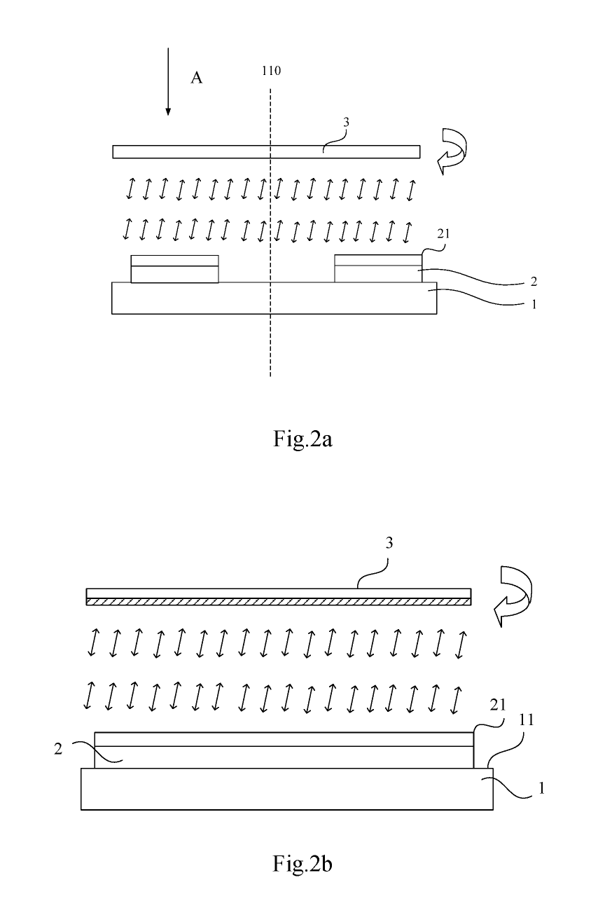

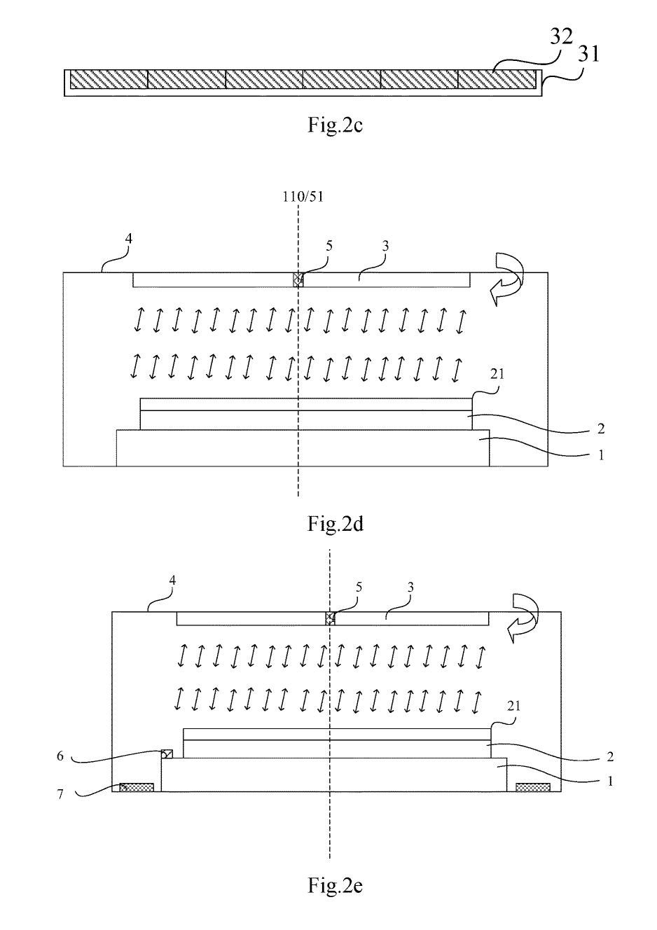

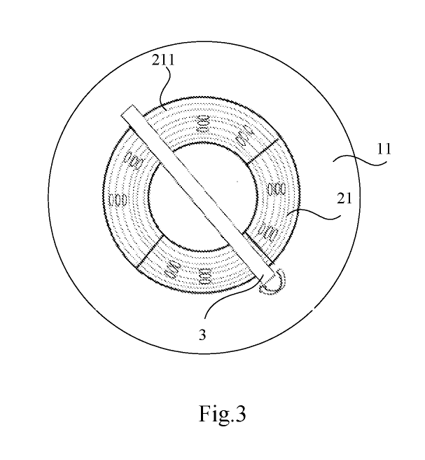

FIG. 2a is a structural schematic diagram of an alignment apparatus provided by one embodiment of the present disclosure; and FIG. 3 is a structural schematic diagram of the alignment apparatus in A direction provided by one embodiment of the present disclosure as illustrated in FIG. 2a.

An alignment apparatus is provided by one embodiment of the present disclosure. As illustrated in FIG. 2a and FIG. 3, the alignment apparatus comprises a base 1, the base 1 is provided with a support surface 11 configured to support a substrate 2; and a photo-alignment film 21 is disposed on a surface of the substrate 2 away from the support surface 11.

The alignment apparatus further comprises: an ultraviolet lamp 3 disposed above the support surface 11, wherein the ultraviolet lamp 3 is configured to rotate around (with respect to) a line 110 perpendicular to the support surface 11 and in a plane parallel to the support surface 11 of the base 1, or the base 1 is configured to rotate around (with respect to) the line 110 perpendicular to the support surface 11 of the base 1.

According to the alignment apparatus provided by the embodiment of the present disclosure, as illustrated in FIG. 3, a plurality of arc substrates 2 are disposed on the base 1 after being spliced into an annular shape (a ring-shape), and by rotating the ultraviolet lamp 3, alignment directions 211, i.e., arc alignment directions 211, which are arranged in a rotating direction of the ultraviolet lamp 3 can be formed in the photo-alignment film 21 on the substrate 2, so that liquid crystal molecules are also correspondingly distributed in an arc surface mode, thereby achieving an arc display panel structure on a substrate. If the substrate adopts an integral non-spliced structure, a circular alignment direction on a substrate can be formed. Therefore, according to the alignment apparatus provided by the embodiment of the present disclosure, the arc or circular alignment direction 211 can be formed so as to obtain a good alignment effect. The alignment apparatus can be suitable for alignment of an alignment film of a non-rectangular panel.

Generally, in a photo-alignment technology, exposure alignment is performed on an alignment film by ultraviolet light, which belongs to a non-contact alignment mode. The liquid crystal molecules are directionally arranged by utilizing anisotropy generated by a photochemical reaction of an ultraviolet photosensitive polymer monomer material. Firstly, one substrate, such as Indium Tin Oxide (ITO) glass, needs to be coated with a layer of photosensitive polymeric film (for example, the photo-alignment film, a film capable of being aligned by photo-alignment, such as a photosensitive PI film), then the substrate is irradiated by ultraviolet polarized light, and only photosensitive groups parallel to a polarization direction of the polarized light are performed a photochemical reaction to generate anisotropy on the alignment film so as to induce liquid crystal molecules to be aligned. Molecules in the photosensitive polymeric film, which are not parallel to the polarization direction of the polarized light, are not performed the photochemical reaction, so as to form structures similar with molecule “grooves”, and thus, directional arrangement of the liquid crystal molecules can be induced. Double-sided arrows in FIGS. 2a, 2b, 2d and 2e represent linearly polarized light.

It should be illustrated as follows:

(1) According to embodiments of the present disclosure, for example, the substrate 2 includes an array substrate or an opposed substrate, but are not limited thereto. For example, the opposed substrate and the array substrate are disposed oppositely, the opposed substrate and the array substrate are respectively two substrates, i.e., upper and lower substrates of the display panel, and generally, display structures such as a thin film transistor array etc. are formed on the array substrate and a color resin is formed on the opposed substrate. For example, the opposed substrate is a color filter substrate.

(2) The line 110 perpendicular to the support surface 11 can be a random line perpendicular to the support surface. For example, the line 110 perpendicular to the support surface is a perpendicular bisector of the support surface 11.

(3) The ultraviolet lamp can intersect the line 110 perpendicular to the support surface 11, or the ultraviolet lamp can don't intersect the line 110 perpendicular to the support surface 11.

(4) In order to form a linearly polarized light, the alignment apparatus can further include a polarizer 10. As illustrated in FIG. 2b, the polarizer 10 is configured to enable light transmitting (going through) the polarizer 10 to be changed into a linearly polarized light, and the polarizer 10 can be disposed in the ultraviolet lamp 3 or located between the ultraviolet lamp 3 and the support surface 11.

(5) FIG. 2a illustrates a circular ring-shaped substrate formed by splicing arc sub-substrates, and FIG. 2b illustrates a circular substrate, but the shape of the substrate is not limited thereto. For example, the substrate can also have a sector shape or a sector circular ring shape. For example, the substrate has a shape of at least one selected from the group consisted of a circle, a sector, a circular ring and a sector circular ring.

Further, in order to improve alignment effect, as illustrated in FIG. 2c, the ultraviolet lamp can include: a lampshade 31, and a plurality of light emitting units 32 disposed in the lampshade 31, wherein a surface of the lampshade toward the support surface is disposed to parallel to the photo-alignment film. “Grooves” (alignments) having a same depth in the photo-alignment film is formed by disposing the surface of the lampshade toward the support surface parallel to the photo-alignment film. It should be illustrated that the surface toward the support surface of the lampshade also can be not parallel to the photo-alignment film, which is not limited herein.

In one example, as illustrated in FIG. 2d, the alignment apparatus can further comprise an alignment chamber 4, and the ultraviolet lamp 3 and the base 1 are disposed in the alignment chamber 4. Design of the alignment chamber can avoid leakage of the ultraviolet light so as to improve a utilization rate of the ultraviolet light.

The ultraviolet lamp 3 is configured to rotate around a line 110 perpendicular to the support surface 11 e.g. around a perpendicular bisector of the support surface of the base 1 with respect to the base, which can be achieved by various modes:

In one optional embodiment, the base 1 is fixed with respect to the alignment chamber, and the ultraviolet lamp 3 is configured to rotate around the line perpendicular to the support surface of the base 1. Namely, the ultraviolet lamp 3 can rotate with respect to the base 1, and the substrate(s) 2 on the base 1 is/are fixed, so that alignment directions (similar with arc “grooves”) 211 can be conveniently formed on the photo-alignment film(s) 21 of the substrate(s) 2.

Further, in one example, as illustrated in FIG. 2d, the ultraviolet lamp 3 is mounted on a top of the alignment chamber by a pivoting shaft 5, and an axis 51 of the pivoting shaft 5 coincide with the line 110 perpendicular to the support surface 11 e.g. the perpendicular bisector of the base 1.

Furthermore, in one example, as illustrated in FIG. 2e, a first delivery device 6 configured to delivery a substrate 2 is disposed on the support surface of the base 1. The substrate 2 is facilitate to be moved to a region to be aligned or to be moved out of the region to be aligned after alignment is completed by the first delivery device 6, thereby working efficiency of the alignment apparatus is improved. The first delivery device can be, but not limited to, one of a delivery rail, a mechanical arm and the like.

Further, in one example, as illustrated in FIG. 2e, the alignment apparatus can further include: a second delivery device 7 which is disposed on two opposite sides of the base 1 and is configured to delivery a substrate 2 such as an arc substrate, so as to improve working efficiency. The second delivery devices can be, but not limited to, delivery rails and the like.

In another optional embodiment, the ultraviolet lamp 3 is fixed with respect to the base 1, and the base 1 is configured to rotate around the line 110 perpendicular to the support surface 11 e.g. around the perpendicular bisector of the support surface. Namely, the ultraviolet lamp 3 is fixed, the base 1 can rotate, and by rotation of the base 1, the substrate 2 is driven to rotate, so that relative motion can be generated between the base 1 and the ultraviolet lamp 3, which is convenient to form arc/round alignment directions (similar with “grooves”) 211 on the photo-alignment film 21 of the substrate 2. In one example, the base 1 is configured to rotate around the perpendicular bisector of the support surface, and a midpoint of the ultraviolet lamp is located at the perpendicular bisector of the support surface.

For example, a distance between a light emitting face of the ultraviolet lamp and the surface away from the support surface of the arc substrate 2 is, but not limited to, 10 μm to 100 μm, such as 10 μm, 11 μm, 12 μm, 16 μm, 18 μm, 30 μm, 40 μm, 60 μm, 80 μm, 90 μm, 100 μm and the like.

For example, a rotating speed of the ultraviolet lamp 3 rotating around the line perpendicular to the support surface of the base 1 with respect to the base 1 or a rotating speed of the base 1 rotating around the line perpendicular to the support surface of the base is, but not limited to, 5 r/min to 50 r/min.

For example, light energy emitted by the ultraviolet lamp 3 is in a range from 3,000 millijoule (mJ) to 10,000 millijoule (mJ), but not limited thereto.

At least one embodiment of the present disclosure also provides a display panel comprising an alignment film. The alignment film in the display panel is formed by any one of the alignment apparatus according to the above-mentioned alignment apparatus, and an alignment direction 211 of the formed alignment film is distributed along an arc or circular shape. Liquid crystal molecules are also distributed according to the arc or circular shape. The display panel provided by the embodiments of the present disclosure can improve a display effect of the display panel and has a good view angle.

At least one embodiment of the present disclosure also provides a display device, including any one of the display panel provided by the embodiments of the present disclosure. The display device has a good display effect. For example, the display device can be any one of products or parts with a display function, such as a notebook computer display panel, electronic paper, an organic light emitting diode display, a liquid crystal display, a liquid crystal television, a digital photo frame, a mobile phone, a watch, a tablet personal computer and the like.

What are described above is related to the illustrative embodiments of the disclosure only and not limitative to the protecting scope of the disclosure. The protecting scopes of the disclosure are defined by the accompanying claims.

This application claims the benefit of priority from Chinese patent application No. 201510594188.1, filed on Sep. 17, 2015, the disclosure of which is incorporated herein in its entirety by reference as a part of the present application.

What is claimed is:

1. An alignment apparatus comprising:
a base, being provided with a support surface configured to support a substrate with a film capable of being aligned by photo-alignment;
an ultraviolet lamp disposed above the support surface,
wherein the ultraviolet lamp is configured to rotate around a line perpendicular to the support surface and in a plane parallel to the support surface of the base, or the base is configured to rotate around the line perpendicular to the support surface of the base.

2. The alignment apparatus according to claim 1, wherein the line perpendicular to the support surface comprises a perpendicular bisector of the support surface.

3. The alignment apparatus according to claim 1, wherein the ultraviolet lamp intersects the line perpendicular to the support surface.

4. The alignment apparatus according to claim 1, wherein the ultraviolet lamp does not intersect the line perpendicular to the support surface.

5. The alignment apparatus according to claim 1, further comprising a polarizer, wherein the polarizer is configured to enable light transmitting the polarizer to be changed into a linearly polarized light, the polarizer is disposed in the ultraviolet lamp or located between the ultraviolet lamp and the support surface.

6. The alignment apparatus according to claim 1, wherein the ultraviolet lamp comprises a lampshade, and a plurality of light emitting units in the lampshade.

7. The alignment apparatus according to claim 6, wherein a surface of the lampshade toward the support surface is disposed to parallel to the film capable of being aligned by photo-alignment.

8. The alignment apparatus according to claim 1, further comprising an alignment chamber, wherein the ultraviolet lamp and the base are disposed in the alignment chamber.

9. The alignment apparatus according to claim 8, wherein the base is fixed with respect to the alignment chamber, and the ultraviolet lamp is configured to rotate around the line perpendicular to the support surface.

10. The alignment apparatus according to claim 9, wherein the ultraviolet lamp is mounted on a top of the alignment chamber by a pivoting shaft, and an axis of the pivoting shaft coincide with the line perpendicular to the support surface around which the ultraviolet lamp rotates.

11. The alignment apparatus according to claim 9, wherein a first delivery device configured to delivery a substrate is disposed on the support surface of the base.

12. The alignment apparatus according to claim 9, wherein a second delivery device configured to delivery a substrate is disposed on two opposite sides of the base.

13. The alignment apparatus according to claim 9, wherein the ultraviolet lamp is fixed with respect to the base, and the base is configured to rotate around the line perpendicular to the support surface.

14. The alignment apparatus according to claim 2, wherein the base is configured to rotate around the perpendicular bisector of the support surface, and a midpoint of the ultraviolet lamp is located at a perpendicular bisector of the support surface.

15. The alignment apparatus according to claim 1, wherein the substrate has a shape of at least one selected from the group consisted of a circle, a sector, a circular ring and a sector circular ring.

16. The alignment apparatus according to claim 1, wherein a distance between a light emitting face of the ultraviolet lamp and the surface of the substrate away from the support surface is 10 μm to 100 μm.

17. The alignment apparatus according to claim 1, wherein a rotating speed of the ultraviolet lamp rotating around the line perpendicular to the support surface of the base with respect to the base or a rotating speed of the base rotating around the line perpendicular to the support surface of the base is 5 r/min to 50 r/min.

18. The alignment apparatus according to claim 1, wherein light energy emitted by the ultraviolet lamp is in a range from 3,000 mJ to 10,000 mJ.

19. A display panel comprising an alignment film, wherein an alignment direction of the alignment film is distributed along an arc or circular shape.

20. A display device comprising the display panel according to claim 19.
